(19) United States
(12) Patent Application Publication
(10) Pub. No.: US 2015/0017923 A1
(43) Pub. Date: Jan. 15, 2015

(54) ADAPTIVE RF CONTROL FOR LTE MEASUREMENTS

(71) Applicant: QUALCOMM Incorporated, San Diego, CA (US)

(72) Inventors: Subbarayudu MUTYA, Hyderabad (IN); Illath Narayanan PAZHEDATH, Hyderabad (IN); Yongle WU, San Diego, CA (US)

(73) Assignee: QUALCOMM Incorporated, San Diego, CA (US)

(21) Appl. No.: 14/086,678

(22) Filed: Nov. 21, 2013

Related U.S. Application Data
(60) Provisional application No. 61/845,895, filed on Jul. 12, 2013.

(51) Int. Cl. H04W 24/10

(52) U.S. Cl. CPC H04W 24/10
USPC 455/67.11

(57) ABSTRACT

Certain aspects of the present disclosure relate to a method and apparatus for wireless communications by a user equipment (UE) having at least two radio frequency (RF) chains and capable of communicating with first and second radio access networks (RANs). In aspects, the UE may utilize both RF chains to measure signals in the first RAN, during a first measurement period, while on the second RAN. The UE may determine signal conditions in the first RAN, based on the measurements, and decide, based on the determined signal conditions, which of the RF chains to use to measure signals in the first RAN during one or more subsequent measurement periods.

### CLAIM OF PRIORITY UNDER 35 U.S.C. §119

This application claims benefit of U.S. Provisional Patent Application Ser. No. 61/845,895, filed 12 Jul. 2013, which is expressly incorporated by reference herein in its entirety.

### BACKGROUND

1. Field

Aspects of the present disclosure generally relate to wireless communications, and more particularly, to adaptively controlling radio frequency (RF) configurations in an effort to more efficiently use RF resources by a user equipment (UE) having at least two RF chains and capable of communicating with first and second radio access networks (RANs).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. These improvements should be applicable to other multi-access technologies and the telecommunication standards that employ these technologies.

### SUMMARY

Certain aspects of the present disclosure provide a method for wireless communications by a user equipment (UE) having at least two radio frequency (RF) chains and capable of communicating with first and second radio access networks (RANs). The method generally includes utilizing both RF chains to measure signals in the first RAN, during a first measurement period, while on the second RAN. The method further comprises determining signal conditions in the first RAN, based on the measurements, and deciding, based on the signal conditions, which of the RF chains to use to measure signals in the first RAN during one or more subsequent measurement periods.

Certain aspects of the present disclosure provide an apparatus for wireless communication having at least two radio frequency (RF) chains and capable of communicating with first and second radio access networks (RANs). The apparatus generally includes means for utilizing both RF chains to measure signals in the first RAN, during a first measurement period, while on the second RAN. The apparatus further comprises means for determining signal conditions in the first RAN, based on the measurements, and means for deciding, based on the determined signal conditions, which of the RF chains to use to measure signals in the first RAN during one or more subsequent measurement periods.

Certain aspects of the present disclosure provide an apparatus for wireless communication having at least two radio frequency (RF) chains and capable of communicating with first and second radio access networks (RANs). The apparatus generally includes at least one processor and a memory coupled to the at least one processor. The at least one processor is generally configured to utilize both RF chains to measure signals in the first RAN, during a first measurement period, while on the second RAN. The at least one processor is generally configured to determine signal conditions in the first RAN, based on the measurements, and decide, based on the determined signal conditions, which of the RF chains to use to measure signals in the first RAN during one or more subsequent measurement periods.

Certain aspects of the present disclosure provide a computer program product for wireless communications, wherein the computer program product is associated with a device having at least two radio frequency (RF) chains and capable of communicating with first and second radio access networks (RANs). The computer program product includes a non-transitory computer-readable medium having code stored thereon. The code may be executable by one or more processors for utilizing both RF chains to measure signals in the first RAN, during a first measurement period, while on the second RAN. The code may further determine signal conditions in the first RAN, based on the measurements, and decide, based on the signal conditions, which of the RF chains to use to measure signals in the first RAN during one or more subsequent measurement periods.

Aspects generally include methods, apparatus, systems, computer program products, and processing systems, as substantially described herein with reference to and as illustrated by the accompanying drawings.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 an exemplary deployment in which multiple wireless networks have overlapping coverage.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIGS. 7-10 illustrate example procedures performed by a UE, in accordance with certain aspects of the present disclosure.

FIG. 11 illustrates example operations performed, for example, by a UE, in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as lx radio transmission technology (1xRTT), CDMA2000 1X, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM.®., etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and RATs mentioned above as well as other wireless networks and RATs.

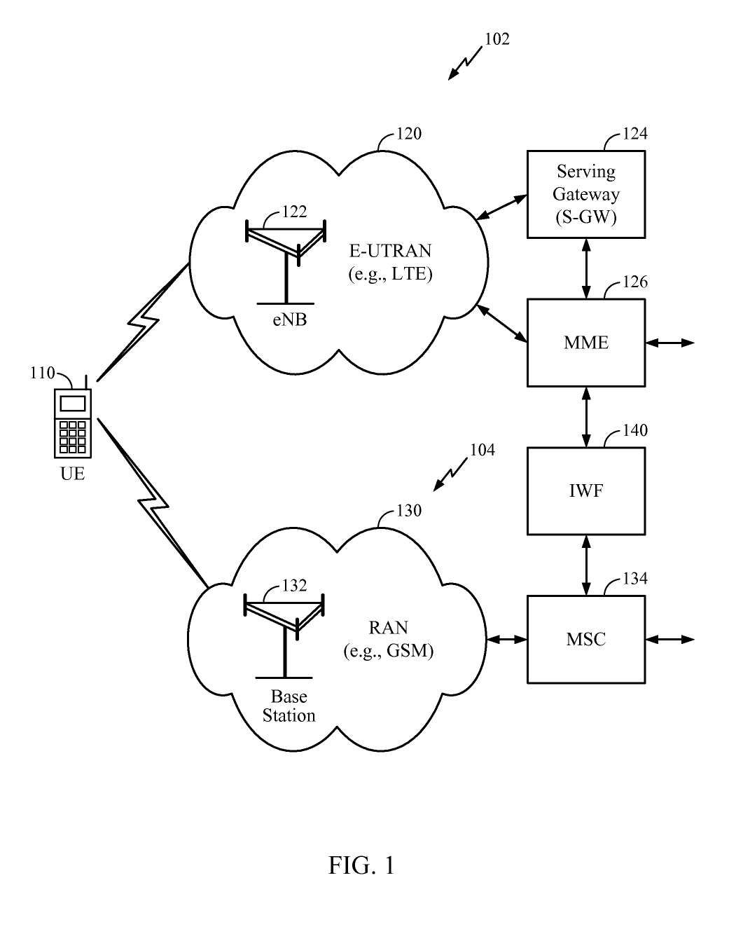

FIG. 1 shows an exemplary deployment in which multiple wireless networks have overlapping coverage. An evolved universal terrestrial radio access network (E-UTRAN) 120 may support LTE and may include a number of evolved Node Bs (eNBs) 122 and other network entities that can support wireless communication for user equipments (UEs). Each eNB may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1xCSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency or frequency ranges may also be referred to as a carrier, a frequency channel, etc. Each frequency or frequency ranges may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1xRTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

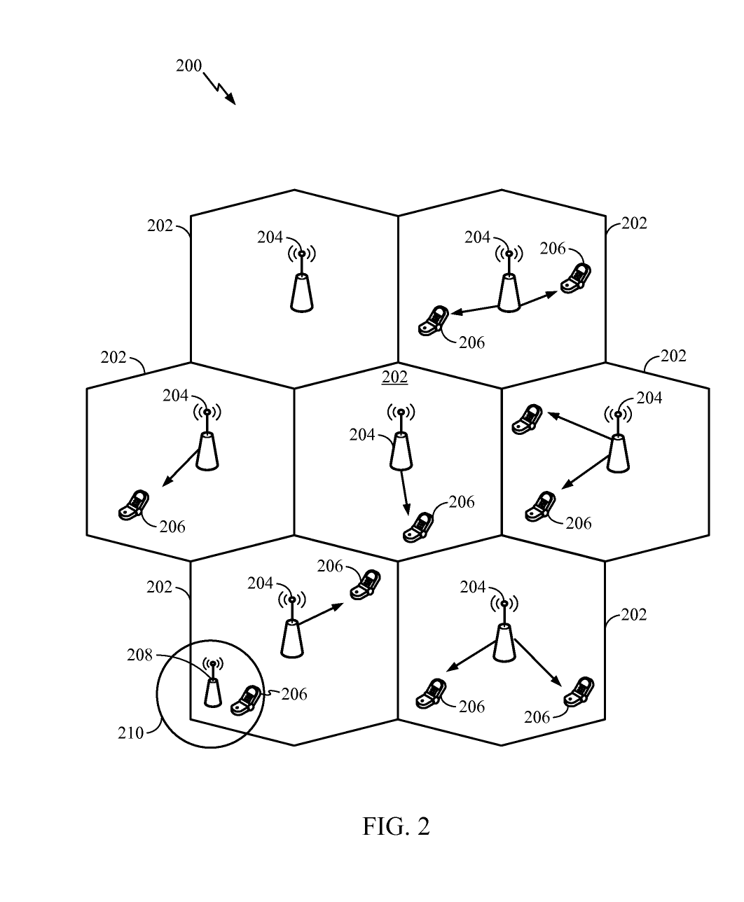

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

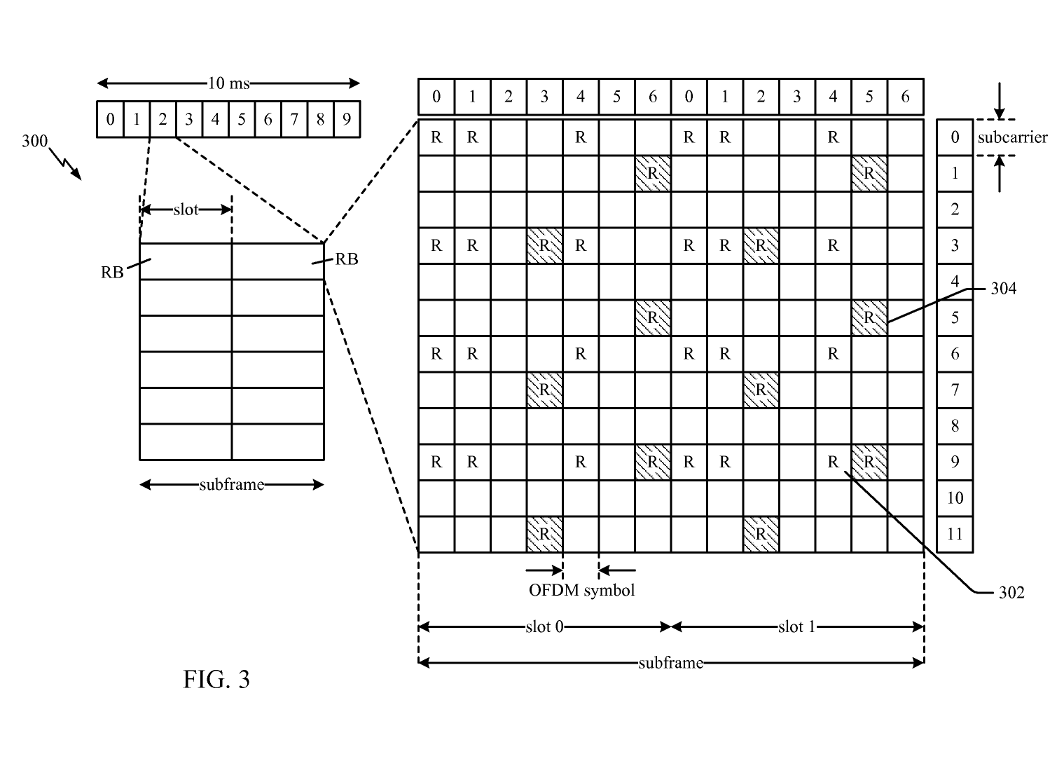

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

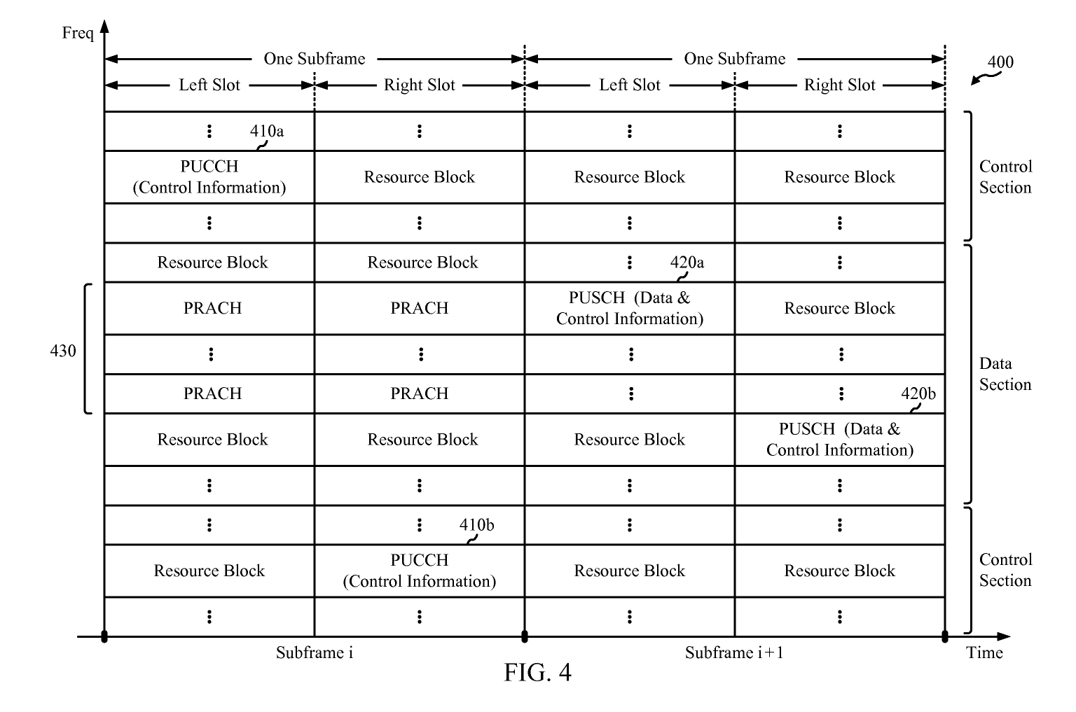

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

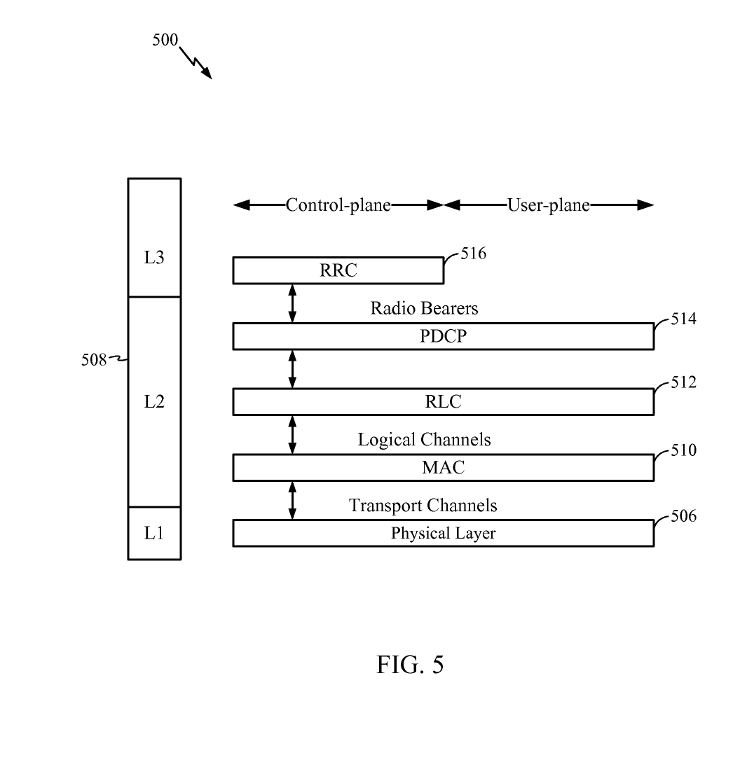

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

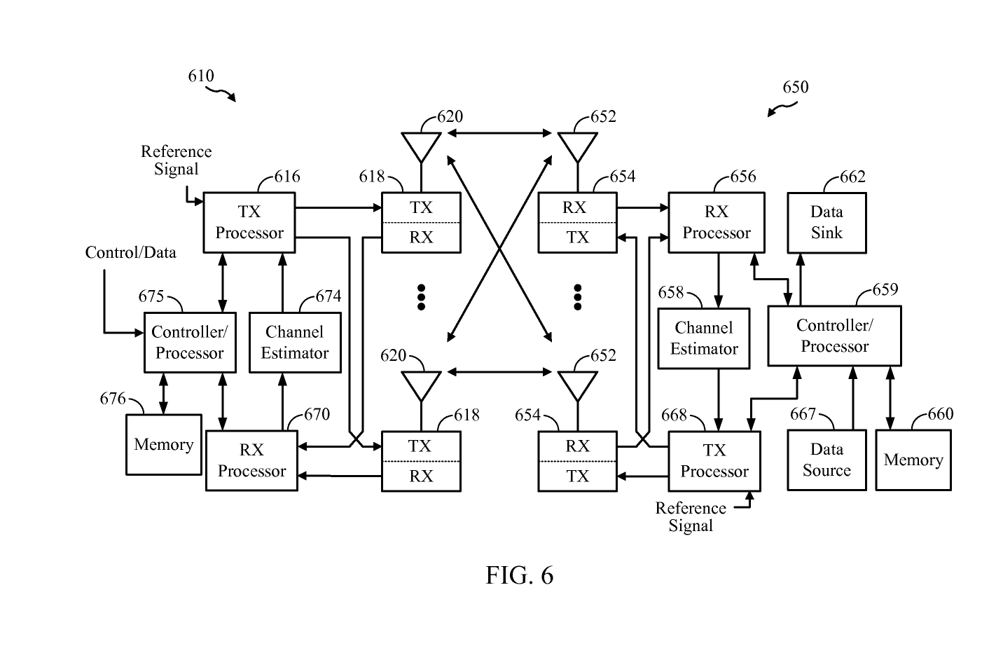

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

UE 110 of FIG. 1 may include one or more components of UE 650 of FIG. 6 and may be configured to adaptively control RF configurations in an effort to more efficiently use RF resources according to aspects described herein.

### EXAMPLE METHODS AND APPARATUS FOR ADAPTIVE RF CONTROL FOR LTE MEASUREMENTS

Wireless terminals typically use two RF chains in LTE radio access systems when communicating with eNBs in an LTE cell. When an LTE capable device (e.g., wireless terminal, UE) moves to a non-LTE coverage area, the device will reselect to the non-LTE system, which may include a Global Systems for Mobile Communications (GSM) system or a Universal Mobile Telecommunication System/Wideband CDMA (UMTS/WCDMA) system, for example.

A UE camping on a non-LTE system may perform periodic searches for LTE system acquisition. In such occasions, the UE may measure LTE samples when in an idle mode. The UE may employ two RF chains to capture (e.g., measure) LTE samples. Subsequently, the UE may select a best sample between the two RF chains for offline processing.

The UE may apply a similar mechanism while in a connected mode of operation in a non-LTE system. For example, the UE may employ two RF chains to attempt to measure LTE carriers during compressed mode gaps.

As will be explained in more detail herein, aspects of the present disclosure provide algorithms for performing LTE measurements when a device is in a non-LTE mode of operation.

Initially, a UE may employ two RF chains and may determine the Reference Signal Received Power (RSRP), Reference Signal Received Quality (RSRQ), and/or Signal to Noise Ratio (SNR) of the UE's primary and diversity antenna (e.g., ant0 and ant1, respectively). During an initial LTE sample capture, the UE may determine one or more signal conditions of the LTE system.

When one or more parameters of ant0 and/or ant1 are greater than a threshold, the UE may set a reference antenna (e.g., reference_ant) based on a computation as shown below, in an effort to select the better RF chain, for subsequent LTE measurements when the UE is in a non-LTE coverage area.

Given:
ParamX is at least one of RSRP, RSRQ, or SNR; and
   PARAMX_MIN_THRESHOLD may be derived from network provided thresholds, when:

ParamX_ant0 (or) ParamX_ant1>PARAMX_MIN_THRESHOLD, the UE may set reference_ant based on:
MAX(ParamX_ant0, ParamX_ant1).

Thus, the UE may set the reference_ant to either ant0 or ant1 based on one or more parameters including RSRP, RSRQ, and/or SNR, for example, in an effort to select which RF chain to configure for LTE measurements while the UE is in a non-LTE coverage area.

After selecting the reference_ant, the UE may use the RF chain associated with the reference_ant for measurements of the LTE cell. The UE may not configure measurements on the RF chains associated with the non-selected antennas.

According to aspects of the present disclosure, a UE may reinitiate this algorithm, to select a RF chain for LTE cell measurements, if a parameter associated with the reference_ant (e.g., RSRP/RSRQ/SNR) falls below a threshold and/or upon expiration of an adaptive diversity control timer. The adaptive diversity control timer may be set to an initial value (e.g., EVAL_DIVERSITY_CHAIN_INT), which may be decremented each time the UE performs one or more measurements of the LTE cell. According to aspects, the timer value may be decremented each time a measurement is taken, regardless of whether the measurement is taken during an idle or compressed mode gap.

As explained above,

Reschedule_ant_paths may be set to TRUE if RSRP/RSRQ/SNR_ant_reference is below PARAM_MIN_THRESHOLD; and/or
Reschedule_ant_paths is set to TRUE if timer adaptive_diversity_control expires.
Timer adaptive_diversity_control is set to initial value EVAL DIVERISTY CHAIN NIT value; and
   Timer adaptive_diversity_control is decremented every time UE performs one or more LTE measurements.

In an effort to account for mobility of the UE, according to aspects, under fast changing radio conditions, the timer adaptive_diversity_control may be dynamically adjusted. For example, the timer adaptive_diversity_control value may be adjusted if the LTE parameter (e.g., RSRP/RSRQ/SNR) measured by the selected reference_ant is changing rapidly (e.g., two consecutive measurements exceeds a threshold). An LTE parameter change greater than a threshold (e.g., RSRP_DELTA_FAST_THR, RSRQ_DELTA FAST THR, and/or SRN DELTA FAST THR) may be used to adjust the timer adaptive_diversity_control value.

Additionally or alternatively, an LTE parameter change greater than a threshold (e.g., RSRP_DELTA_FAST_THR, RSRQ_DELTA_FAST_THR, and/or SRN_DELTA_FAST_THR) may be used to reinitiate the antenna selection process. When reinitiating the antenna selection process, the UE may measure the LTE cell using both ant0 and ant1 in an effort to select a reference_ant for LTE measurements while the UE is in a non-LTE coverage area.

In an effort to account for mobility of the UE, according to aspects, under slow changing radio conditions, the timer adaptive_diversity_control value may be dynamically adjusted. For example, the adaptive_diversity_control timer value may be adjusted if the LTE parameter (e.g., RSRP/RSRQ/SNR) measured by the selected reference_ant is not changing rapidly (e.g., two consecutive measurements less than a threshold). A change slower than a threshold (e.g., RSRP_DELTA_SLOW_THR, RSRQ_DELTA_SLOW_THR, SNRDELTA_SLOW_THR) may be used to trigger changes to the adaptive_diversity_control timer.

As will be described in more detail herein, aspects of the present disclosure may be used to more efficiently measure weak LTE cells while the UE is in a non-LTE coverage area. The weak LTE cells may appear in a search result, but may not be likely candidates for handover and/or reselection. The adaptive diversity algorithm may be applied such that only the selected reference antenna, and not all (e.g., both) antennas, may be configured for measurements of weak LTE cells.

The parameters and measurements described above may be used in an effort to more effectively utilize radio resources which may decrease power consumption by the UE. For example, power consumption gains may be obtained by using only the selected RF chain for LTE measurements (e.g., not using phase-locked loops (PLLs), Low Noise Amplifier (LNA), general purpose input/outputs (GPIO), and/or general radio frequency center (GRFC) of non-selected RF chains).

Additionally, when a RF chain is not configured to perform LTE measurements, the UE may realize time benefits, for example time benefits in protocol to update and write new parameters ((e.g., number. of SSBI writes x SSBI_WRITE_TIME+Delays for PLL settling, where SSBI_WRITE_TIME normally is 3 us).

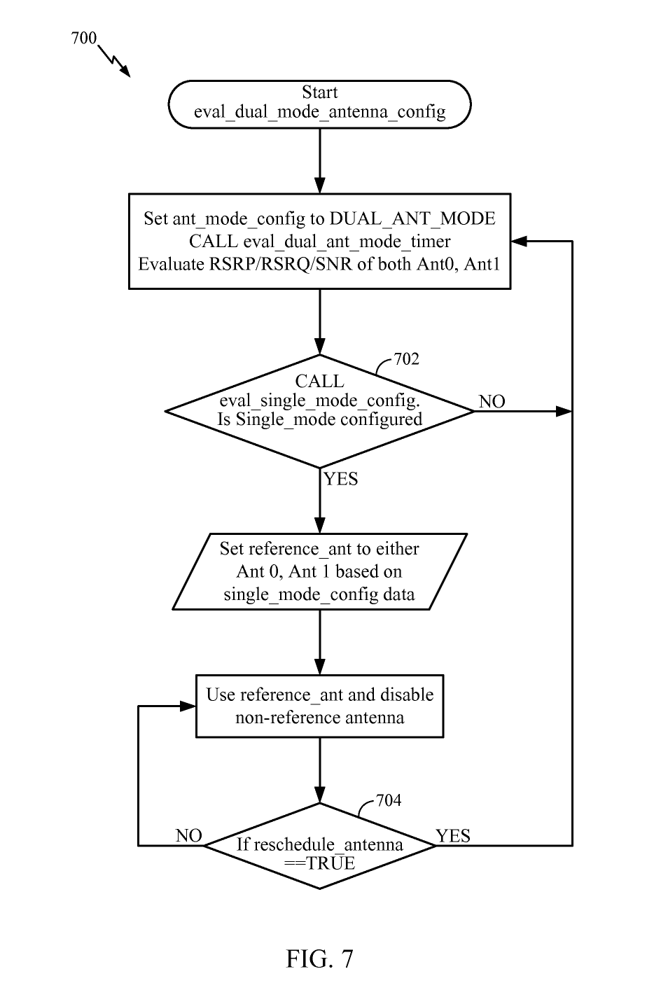

FIG. 7 illustrates an example methodology 700 for evaluating a dual mode antenna configuration, performed by a UE, according to aspects of the present disclosure. Initially, the UE may set the antenna mode configuration to a dual antenna mode. An eval_dual_ant_mode_timer may be initiated and the UE may evaluate LTE parameters using both ant0 and ant1. As described above, the parameters may be at least one of RSRP, RSRQ, or SNR.

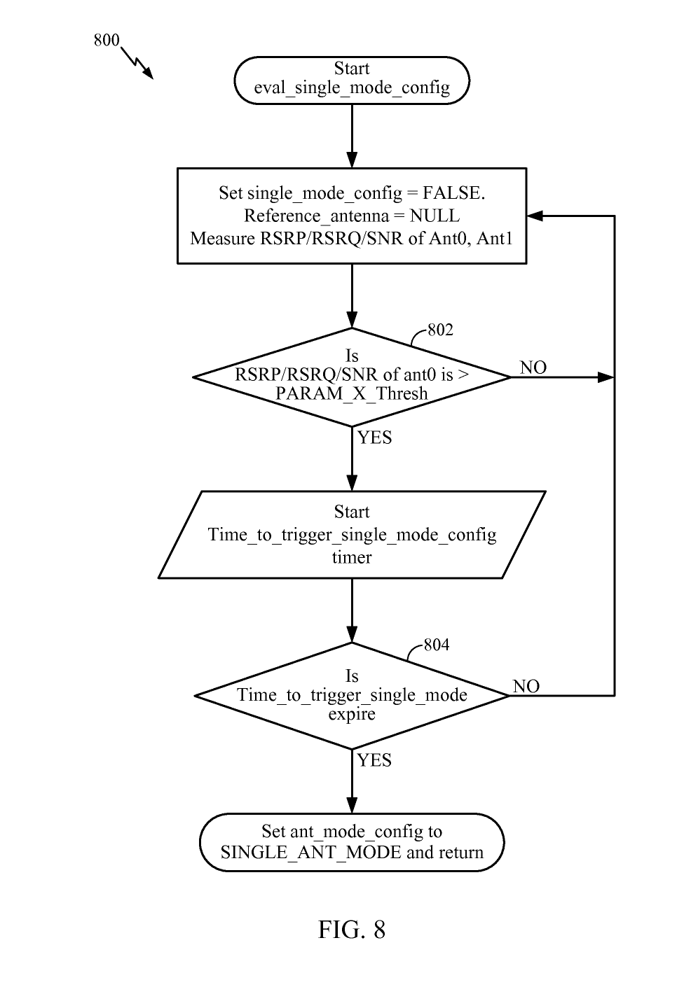

At 702, the UE may determine if the single mode is configured (which will be explained in more detail below, for example, with reference to FIG. 8). If it is determined that the single mode is configured, the UE may set a reference antenna based on the single_mode_config data. The UE may use the selected reference antenna and may disable the non-selected antenna.

If, at 702, if the single mode is not configured, the UE may, again, set the antenna mode configuration to the dual_ant_mode, initiate the eval_dual_ant_mode_timer, and evaluate LTE parameters using both ant0 and ant1.

At 704, if reschedule_antenna is determined to be TRUE, the UE may reinitiate the process by setting the antenna mode configuration to a dual_ant_mode, initiating the evaldual_ant_mode_timer, and evaluating LTE parameters using both ant0 and ant1.

If, at 704, reschedule_antenna is determined to be false, the UE may continue to use the selected reference antenna.

FIG. 8 illustrates an example methodology 800 for evaluating a single mode antenna configuration, performed by a UE, according to aspects of the present disclosure. A UE may set a single_mode_config to FALSE and reference antenna to NULL. Using both ant0 and ant1, the UE may measure one or more parameters (e.g., RSRP/RSRQ/SNR) of an LTE cell.

At 802, if the measured LTE parameter associated with one or more antennas (e.g., ant0) is greater than a parameter threshold (PARAM_X_Thresh), the UE may start a time to trigger single mode configuration timer. At 804, when the trigger single mode configuration timer expires, the UE may set the antenna mode configuration to the single_ant_mode. If the time to trigger single mode has not expired, the UE may use both ant1 and ant0 to measure LTE parameters.

If, at 802, measured LTE parameter associated with one or more antennas is not greater than the parameter threshold, the UE may, again, set the single_mode_config to FALSE and reference antenna to NULL. Using both ant0 and ant1, the UE may measure one or more LTE parameters.

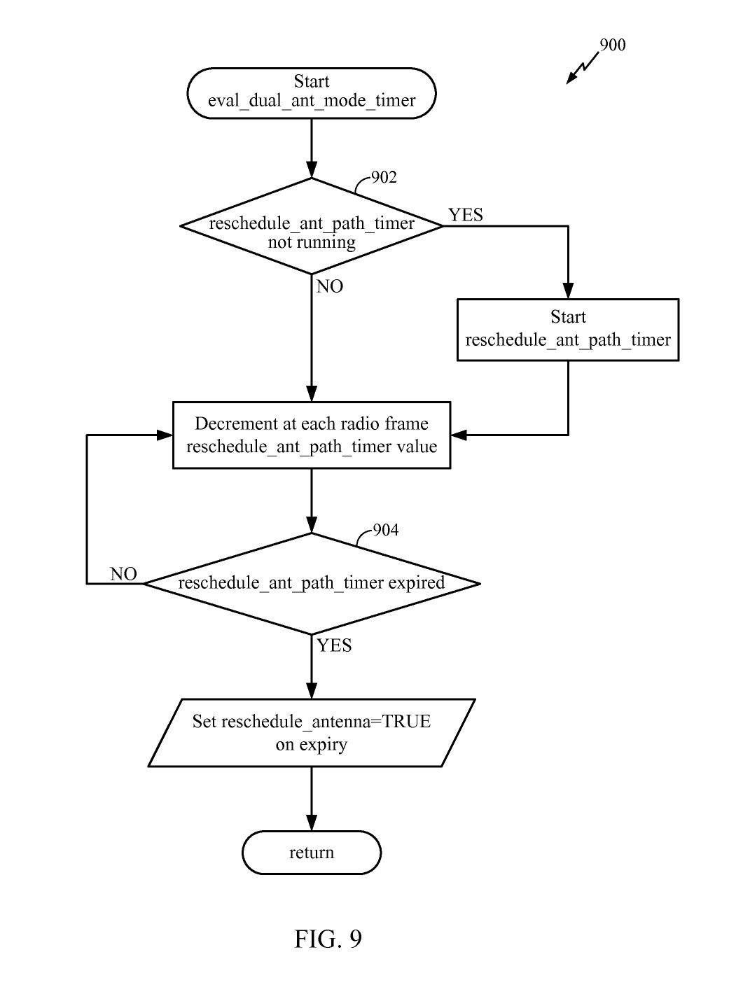

FIG. 9 illustrates an example methodology 900, which may be performed by a UE, according to aspects of the present disclosure. At 902, when the reschedule_ant_path_timer is running, the UE may decrement the count of the timer, for example, at each radio frame (e.g., every time UE performs LTE one or more measurements). When, at 904, the reschedule_ant_path_timer expires, the UE may reselect a reference antenna (e.g., reschedule_antenna=TRUE).

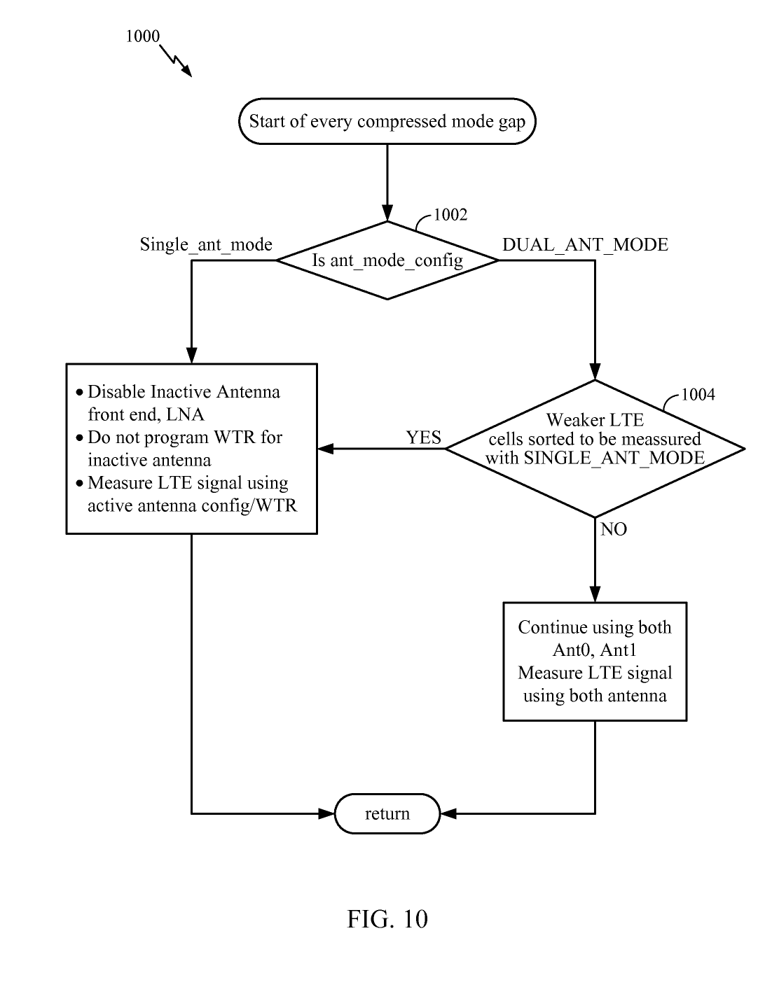

FIG. 10 illustrates an example methodology 1000, which may be performed by a UE, according to aspects of the present disclosure. At the start of every compressed mode gap, the UE may determine, at 1002, if it is configured for single antenna mode or dual antenna mode. If the UE is dual antenna mode configured, one or more weak LTE cells may be detected and/or sorted, in an effort to determine which cells may be measured using a single antenna mode. If it is determined that weak cells (e.g., weaker than other detected LTE cells) exist, which may be measured using the single antenna mode configuration, the UE may disable the inactive antenna's front end and/or LNA. As well, the UE may not use software programming for the inactive antenna. The UE may measure the LTE signal using the active antenna configuration.

If the UE is configured in the dual antenna mode and weak LTE cells do not exist which may be measured using the single antenna mode, the UE may continue to operate using both ant0 and ant1. Accordingly, the UE may measure LTE signals using both antennas.

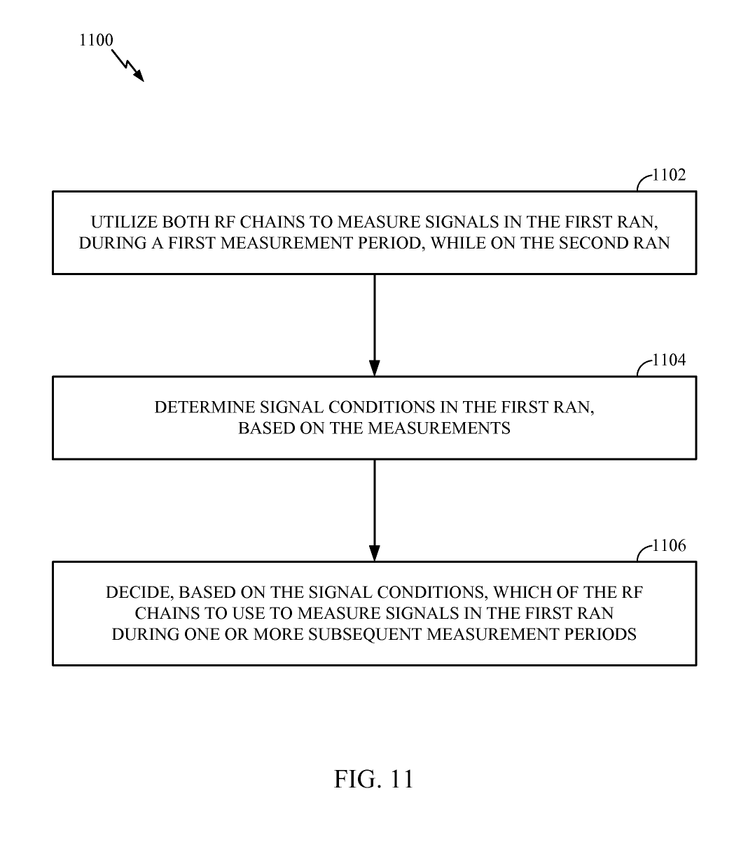

FIG. 11 is a flow diagram illustrating operations 1100 performed by a user equipment (UE) having at least two radio frequency (RF) chains and capable of communicating with first and second radio access networks (RANs), according to aspects of the present disclosure. UE 110 of FIG. 1, which may include one or more components of UE 650 of FIG. 6 may perform operations 1100 of FIG. 11.

The first RAN may be an LTE network and the second RAN may include, for example, a GSM or UMTS/WCDMA network. At 1102, the UE may utilize both RF chains to measure signals in the first RAN, during a first measurement period, while on the second RAN (e.g., in an idle or connected mode). At 1104, the UE may determine signal conditions in the first RAN, based on the measurements. At 1106, the UE may decide, based on the signal conditions, which of the RF chains to use to measure signals in the first RAN during one or more subsequent measurement periods.

As described herein, the UE may decide, based on the signal conditions, to use both RF chains to measure signals in the first RAN during the subsequent measurement periods.

According to aspects, the UE may determine signal conditions of the first RAN by determining whether at least one signal quality parameter (e.g., RSRP/RSRQ/SNR) exceeds a first threshold value. The first threshold value may be derived from one or more network provided threshold values. The UE may decide to use a RF chain with a highest value for the signal quality parameter as a reference RF chain. As described above, according to aspects, the UE may decide to use only the reference RF chain for measurements in one or more subsequent measurement periods.

The UE may further sort cells of the RAN (e.g., LTE RAN) based on a measured signal strength. The UE may decide to use a RF chain having a highest value for the signal quality parameter as the reference RF chain by deciding to use only the reference RF chain for measurements in one or more subsequent measurement periods.

As described above, the UE may switch which RF chain is used as a reference RF chain, for example, based on subsequent measurements utilizing both RF chains. For example, the subsequent measurements utilizing both RF chains may be in response to detecting the signal quality parameter for the reference RF chain is below a second threshold value.

According to aspects, the subsequent measurements utilizing both RF chains may be in response to detecting expiration of a timer. The timer may be decremented during each measurement period. Additionally, or alternatively, the value of the timer may be adjusted based on a detected mobility of the UE.

As described above, the detected mobility of the UE may be based, at least in part, on changes in the signal quality parameter. According to aspects, the UE may take subsequent measurements utilizing both RF chains in response to detected mobility of the UE.

The mobility of the UE may be detected based, at least in part, on changes in the signal quality parameter (e.g., RSRP/RSRQ/SNR). The value of the timer may be adjusted based on a rate of change in detected radio conditions.

As described herein, adaptively controlling antenna configurations for LTE measurements when a UE is in non-LTE system may decrease UE power consumption due to the fact that a reduced number of RF chains (e.g., one, the better RF chain) may be used during the measurement periods.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Although some aspects above are described in the context of two RF chains and selecting one such chain for RF measurements, other aspects include methods and apparatus for wireless communications by a user equipment (UE) having at least two radio frequency (RF) chains and capable of communicating with first and second radio access networks (RANs). The method generally includes utilizing a plurality of RF chains to measure signals in the first RAN, during a first measurement period, while on the second RAN, determining signal conditions in the first RAN, based on the measurements, and deciding, based on the signal conditions, a subset of the plurality of RF chains to used to measure signals in the first RAN during one or more subsequent measurement periods. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communications by a user equipment (UE) having at least two radio frequency (RF) chains and capable of communicating with first and second radio access networks (RANs), comprising:
utilizing both RF chains to measure signals in the first RAN, during a first measurement period, while on the second RAN;
determining signal conditions in the first RAN, based on the measurements; and
deciding, based on the determined signal conditions, which of the RF chains to use to measure signals in the first RAN during one or more subsequent measurement periods.

2. The method of claim 1, wherein the first RAN comprises a Long Term Evolution (LTE) network.

3. The method of claim 1, wherein the deciding which of the RF chains to use to measure signals in the first RAN during one or more subsequent measurement periods comprises:
deciding to use both RF chains to measure signals in the first RAN during one or more subsequent measurement periods.

4. The method of claim 1, wherein determining signal conditions comprises:
determining, for at least one of the RF chains, whether at least one signal quality parameter exceeds a first threshold value.

5. The method of claim 4, further comprising deriving the first threshold value from one or more network provided threshold values.

6. The method of claim 4, wherein the deciding which of the RF chains to use to measure signals in the first RAN during one or more subsequent measurement periods comprises:
deciding to use a RF chain having a highest value for the signal quality parameter as a reference RF chain for measuring signals in the first RAN during the one or more subsequent measurement periods.

7. The method of claim 6, further comprising:
sorting cells of the first RAN based on measured signal strength;
wherein deciding to use the RF chain having the highest value for the signal quality parameter as the reference RF chain includes deciding to use only the reference RF chain for measurements in the one or more subsequent measurement periods based, at least in part, on the sorting.

8. The method of claim 6, further comprising deciding to use only the reference RF chain for measurements in the one or more subsequent measurement periods.

9. The method of claim 8, further comprising:
switching which RF chain is used as the reference RF chain based, at least in part, on subsequent measurements utilizing both RF chains.

10. The method of claim 9, further comprising:
taking the subsequent measurements utilizing both RF chains in response to detecting the signal quality parameter for the reference RF chain is below a second threshold value.

11. The method of claim 9, further comprising:
taking the subsequent measurements utilizing both RF chains in response to detecting expiration of a timer.

12. The method of claim 11, further comprising decrementing the timer each measurement period.

13. The method of claim 11, further comprising adjusting a value of the timer based on detected mobility of the UE.

14. The method of claim 13, further comprising detecting mobility of the UE based on changes in the signal quality parameter.

15. The method of claim 11, further comprising taking the subsequent measurements utilizing both RF chains in response to detected mobility of the UE.

16. The method of claim 15, further comprising detecting mobility of the UE based on changes in the signal quality parameter.

17. The method of claim 11, further comprising adjusting a value of the timer based on a rate of change in detected radio conditions.

18. An apparatus for wireless communications by a user equipment (UE) having at least two radio frequency (RF) chains and capable of communicating with first and second radio access networks (RANs), comprising:
means for utilizing both RF chains to measure signals in the first RAN, during a first measurement period, while on the second RAN;
means for determining signal conditions in the first RAN, based on the measurements; and
means for deciding, based on the determined signal conditions, which of the RF chains to use to measure signals in the first RAN during one or more subsequent measurement periods.

19. The apparatus of claim 18, wherein the first RAN comprises a Long Term Evolution (LTE) network.

20. The apparatus of claim 18, wherein the means for deciding which of the RF chains to use to measure signals in the first RAN during the one or more subsequent measurement periods comprises:
means for deciding to use both RF chains to measure signals in the first RAN during one or more subsequent measurement periods.

21. The apparatus of claim 18, wherein the means for determining signal conditions comprises:
means for determining, for at least one of the RF chains, whether at least one signal quality parameter exceeds a first threshold value.

22. The apparatus of claim 21, wherein the means for deciding which of the RF chains to use to measure signals in the first RAN during one or more subsequent measurement periods comprises:
means for deciding to use a RF chain having a highest value for the signal quality parameter as a reference RF chain for measuring signals in the first RAN during the one or more subsequent measurement periods.

23. The apparatus of claim 22, further comprising:
means for sorting cells of the first RAN based on measured signal strength;
wherein the means for deciding to use the RF chain having the highest value for the signal quality parameter as the reference RF chain includes means for deciding to use only the reference RF chain for measurements in the one or more subsequent measurement periods based, at least in part, on the sorting.

24. The apparatus of claim 22, further comprising:
means for deciding to use only the reference RF chain for measurements in the one or more subsequent measurement periods.

25. The apparatus of claim 24, further comprising:
means for switching which RF chain is used as the reference RF chain based, at least in part, on subsequent measurements utilizing both RF chains.

26. The apparatus of claim 25, further comprising:
means for taking the subsequent measurements utilizing both RF chains in response to detecting the signal quality parameter for the reference RF chain is below a second threshold value.

27. The apparatus of claim 25, further comprising:
means for taking the subsequent measurements utilizing both RF chains in response to detecting expiration of a timer.

28. The apparatus of claim 27, further comprising:
means for adjusting a value of the timer based on a rate of change in detected radio conditions.

29. An apparatus for wireless communications by a user equipment (UE) having at least two radio frequency (RF) chains and capable of communicating with first and second radio access networks (RANs), comprising:
at least one processor configured to:
utilize both RF chains to measure signals in the first RAN, during a first measurement period, while on the second RAN;
determine signal conditions in the first RAN, based on the measurements; and
decide, based on the determined signal conditions, which of the RF chains to use to measure signals in the first RAN during one or more subsequent measurement periods;
and a memory coupled to the at least one processor.

30. A computer program product for wireless communications, wherein the computer program product is associated with a device having at least two radio frequency (RF) chains and capable of communicating with first and second radio access networks (RANs), the computer program product comprising a non-transitory computer-readable medium having code stored thereon, the code executable by one or more processors for:
utilizing both RF chains to measure signals in the first RAN, during a first measurement period, while on the second RAN;
determining signal conditions in the first RAN, based on the measurements; and
deciding, based on the signal conditions, which of the RF chains to use to measure signals in the first RAN during one or more subsequent measurement periods.
